(19) United States
(12) Patent Application Publication
(10) Pub. No.: US 2020/0081899 A1
(43) Pub. Date: Mar. 12, 2020

(54) AUTOMATED DATABASE SCHEMA MATCHING

(71) Applicant: PricewaterhouseCoopers LLP, New York, NY (US)

(72) Inventors: Srineel SHAPUR, San Diego, CA (US); Sasidharan KUMAR, Salem (IN); Kunal SINHA, Bangalore (IN); Vinaya ALVA, Bangalore (IN)

(21) Appl. No.: 16/429,481

(22) Filed: Jun. 3, 2019

Related U.S. Application Data
(60) Provisional application No. 62/730,501, filed on Sep. 12, 2018.

(51) Int. Cl. G06F 16/25; G06F 16/21; G06F 16/22

(52) U.S. Cl. CPC G06F 16/258; G06F 16/2237; G06F 16/211

(57) ABSTRACT

Described are system, method, and computer-program product embodiments for automatically ingesting data from disparate data sources into a target database having a target data schema. In some embodiments, the data is received in a data file including data columns formatted according to a data schema, and a data dictionary describing the source data columns. Count data is generated for each cell selected from a data column, each count datum including counts of occurrences of a detected characteristic in each cell. One or more target data columns from the target data schema can be selected and displayed to a user as being semantically related to the data column based on the count data for each cell, a column header of the data column, and the data dictionary. Based on input received from the user, a data table is generated to store the source columns and loaded into the target database.

### CROSS REFERENCE TO RELATED APPLICATIONS

This application claims the benefit of U.S. Provisional Application No. 62/730,501, filed on Sep. 12, 2018, the entire contents of which is herein incorporated by reference in its entirety and for all purposes.

### FIELD OF THE DISCLOSURE

This disclosure relates generally to systems and methods for performing database schema matching and, more specifically, for performing automatic ingestion of data from disparate data sources, having respective data schemas, into a target database having a target data schema.

### BACKGROUND OF THE DISCLOSURE

Database administrators and data integration engineers often need to perform schema matching and mapping to ingest client data files into a target database. Schema matching is the process by which a target data column from the target database is selected for each source data column, from the source data file, as being semantically related to that source data column. Once the schema of the file is matched to the target schema of the target database, schema mapping can be performed, in which a new data table can be generated that transforms the schemas of the source data columns into the schemas of the corresponding, semantically-related target data columns of the target database.

### SUMMARY OF THE DISCLOSURE

Traditionally, schema matching and mapping is performed manually by a user who is ingesting data from disparate data sources into a target database. For example, the user may be a database administrator or a data integration engineer. Not only is this data ingestion process very time consuming, but also it is highly prone to user error. As the size and volume of data schemas continue to grow and the number of different types of data sources (e.g., web data sources) increases, there exists a greater need for implementing an automated mechanism for performing schema matching and mapping. Automated schema matching can particularly be useful in web-oriented data integration, e-commerce, schema integration and migration, data warehousing, database design, and component-based development.

Automating schema matching, however, is technically challenging to implement because data schemas for data sources and the target data schema for the target databases are typically developed in silos by different entities to address different problems. As a result, the source data schemas and the target data schema have very different structures (e.g., data types and constraints) and conventions (e.g., naming conventions). Moreover, there exists no mechanism to utilize the schema matches determined for a data file (associated with a data source) to match schemas of future data files.

To address the problems noted above, the disclosed embodiments describe system, method, apparatus, and computer program product embodiments for automatically ingesting data from disparate data sources into a target database. In some embodiments, automatic ingestion of the data can include matching and mapping data schemas of the disparate data sources to a target data schema of the target database. In some embodiments, a method for automatically ingesting data from disparate data sources into a target database includes receiving, from a user, a data file including a plurality of source data columns formatted according to a data schema of a data source. The data file can also include a data dictionary storing information that describes the plurality of source data columns. Then, for a source data column of the plurality of source data columns, the method includes generating a plurality of count data for each cell of a plurality of cells selected from that source column. Each count datum of the count data includes a number of occurrences of a characteristic detected in each cell. One or more target data columns can be selected from a plurality of target data columns, specified in the target data schema, as being semantically related to the source data column based on the plurality of count data for each cell, a column header of the source data column, and the data dictionary. Once one or more target data columns are selected for the source data column, one or more graphical representations corresponding to the one or more selected target data columns can be displayed to the user. In some embodiments, the method includes receiving, from the user, an input that selects a graphical representation corresponding to a first target data column from the one or more selected target data columns. To complete the data ingestion process, the method includes generating a data table for storing the plurality of source data columns, where the data table transforms the data schema of the data file into the target data schema of the target database such that the source data column corresponds to the first target data column, and loading the generated data table into the target database.

In some embodiments, the one or more graphical representations corresponding to the one or more target data columns selected for the source data column can be viewed by the user within a user interface configured to graphically aid the user to perform data ingestion. The one or more target data columns can correspond to likely matches of the source data column. Accordingly, the method can ease automated data ingestion by enabling the user to quickly identify and select target data columns displayed by the user interface to match source data columns. In some embodiments, by utilizing three sources of information including a column header for a source data column, contents of the source data column, and a data dictionary associated with the source data column, automated schema matching can be performed with high accuracy compared with existing tools that rely on limited information such as only one source of information. Additionally, using these three sources of information enables the disclosed method to avoid overfitting by averaging out the biases of each information source and reducing the variance.

Moreover, the user interface can be configured to request the user to confirm a correct match for each source data column, and the user feedback can be used to improve the accuracy of a machine learning model used to match source data columns of future data files to the target data columns of the target database. In some embodiments, feedback from the user, including the user's selection that matches the first target data column to the source data column, can be used to generate a training dataset to re-train the machine learning model to increase its accuracy.

In some embodiments, a method for automatically ingesting data from disparate data sources having respective data schemas into a target database having a target data schema, comprises: receiving, from a user, a data file comprising a plurality of source data columns formatted according to a data schema of a data source and comprising a data dictionary comprising information describing the plurality of source data columns; generating a plurality of count data for each cell of a plurality of cells selected from a source data column of the plurality of source data columns, each count datum comprising a number of occurrences of a characteristic detected in each cell; selecting one or more target data columns from a plurality of target data columns specified in the target data schema as being semantically related to the source data column based on the plurality of count data for each cell, a column header of the source data column, and the data dictionary; displaying, to the user, one or more graphical representations corresponding to the one or more target data columns selected for the source data column; receiving an input from the user that selects a graphical representation corresponding to a first target data column from the one or more selected target data columns for the source data column; storing the plurality of source data columns in a data table generated to transform the data schema of the data file into the target data schema of the target database, wherein the source data column corresponds to the first target data column; and loading the generated data table into the target database.

In some embodiments, selecting one or more target data columns from the plurality of target data columns specified in the target data schema comprises: determining one or more clusters from a plurality of clusters associated with the target data schema based on the plurality of count data for each cell; and selecting a first set of data columns from the plurality of target data columns based on the one or more determined clusters, wherein the first set of data columns comprises the one or more target data columns.

In some embodiments, the method comprises: generating a second plurality of count data for each cell of a plurality of cells selected from each target data column of the plurality of target data columns of the target database; clustering the plurality of cells for each target data column into the plurality of clusters based on the second plurality of count data for each cell; and associating a set of target data columns from the plurality of target data columns with each cluster based on a number of cells from the set of target data columns being grouped into the cluster.

In some embodiments, determining the one or more clusters comprises: executing a machine learning algorithm configured to assign a cluster from the plurality of clusters to each cell based on the plurality of count data for each cell.

In some embodiments, selecting one or more target data columns from the plurality of target data columns specified in the target data schema comprises: selecting a second set of data columns from the first set of data columns based on header comparisons between the source data column and each target data column of the first set of data columns, wherein the second set of data columns comprises the one or more target data columns.

In some embodiments, selecting the second set of data columns comprises: for each header comparison between the source data column and each target data column of the first set of data columns, determining a number of string operations to convert the source data column into the target data column; and selecting the second set of data columns from the first set of data columns based on the number of string operations determined for each target data column of the first set of data columns. In some embodiments, each of the string operations comprises deleting a character, adding a character, or substituting a character.

In some embodiments, selecting one or more target data columns from the plurality of target data columns specified in the target data schema comprises: selecting a third set of data columns from the second set of data columns based on data description comparisons between the source data column and each target data column of the second set of data columns, wherein the third set of data columns comprises the one or more target data columns, and wherein the data dictionary comprises the data description for the source data column.

In some embodiments, selecting the third set of data columns from the second set of data columns comprises: vectorizing a data description of the source data column to generate a source vector; vectorizing the second set of data columns to generate a set of corresponding target vectors; calculating a set of distances corresponding to distances between the source vector and each target vector of the set of target vectors; and selecting the third set of data columns from the second set of data columns based on the set of calculated distances.

In some embodiments, the third set of data columns correspond to the one or more selected target data columns, and the method includes: calculating one or more scores corresponding to the one or more selected target data columns based on the set of distances calculated for the third set of data columns; and displaying the one or more scores proximate to the one or more graphical representations corresponding to the one or more selected target data columns.

In some embodiments, generating the plurality of count data comprises: randomly selecting a predetermined number of cells from the source data column, wherein the predetermined number of cells corresponds to the plurality of selected cells.

In some embodiments, the number of occurrences of a characteristic detected in each cell comprises: a number of alphabetical characters in the cell, a number of digits in the cell, a number of white spaces in the cell, a number of special characters in the cell, a number of total characters in the cell, a number of people names identified in the cell, a number of location names identified in the cell, a number of nouns identified in the cell, or a number of verbs identified in the cell.

In some embodiments, displaying the one or more graphical representations corresponding to the one or more selected target data columns comprises: displaying a graphical icon next to the first target data column from the one or more selected target data columns indicating that the first target data column was previously selected by the user for the source data column.

Systems and non-transitory computer-readable storage medium embodiments for performing the method are also provided.

### BRIEF DESCRIPTIONS OF THE DRAWINGS

The foregoing summary, as well as the following detailed description of embodiments, is better understood when read in conjunction with the appended drawings. For the purpose of illustrating the present disclosure, the drawings show example embodiments of the disclosure; the disclosure, however, is not limited to the specific methods and instrumentalities disclosed. In the drawings:

FIG. 1 illustrates a system for automatically ingesting data from disparate data sources into a target database, according to some embodiments;

FIG. 2 illustrates a diagram showing an example data file to be ingested into a target database associated with an example target data schema and an example target data dictionary, according to some embodiments;

FIG. 3 illustrates a diagram showing how one or more target data columns are selected as possible matches for a source data column, according to some embodiments; and

FIG. 4 illustrates a diagram showing how a clustering model is generated, according to some embodiments;

FIG. 5 illustrates a method for automatically ingesting data from disparate data sources into a target database, according to some embodiments;

FIG. 6 illustrates a method for automatically selecting one or more target data columns as possible matches for a source data column, according to some embodiments;

FIG. 7 illustrates a method for configuring a machine learning model to enable automatically ingesting data from disparate data sources into a target database, according to some embodiments;

FIG. 8 illustrates an example of a computing device, according to some embodiments;

FIG. 9 illustrates graphical user interfaces (GUIs) for enabling a user to upload a data file associated with a data source, according to some embodiments;

FIG. 10 illustrates a GUI for enabling a user to request a data integration application to integrate data in a data file with a target database, according to some embodiments;

FIG. 11 illustrates a GUI for enabling a user to confirm correspondences between source data columns of a data file and target data columns of a target database, according to some embodiments; and

FIG. 12 illustrates a GUI showing schema mappings based on user-selected schema correspondences between source data columns of a data file and target data columns of a target database, according to some embodiments.

### DETAILED DESCRIPTION

Described below are systems, methods, apparatuses, and computer program product embodiments for automatically ingesting data from disparate data sources having respective data schemas into a target database having a target data schema. In some embodiments, the data is received in a data file selected by a user. The data file can include source data columns structured according to a data schema and include a data dictionary storing information describing the source data columns. Count data is generated for each cell of a plurality of cells selected from a source data column with each count datum including a number of occurrences of a characteristic detected in each cell. One or more target data columns from target data columns specified in the target data schema can be selected as being semantically related to the source data column based on the count data for each cell, a column header of the source data column, and the data dictionary. Once the one or more target data columns are selected for the source data column, one or more graphical representations corresponding to the one or more selected target data columns can be displayed to the user. As further described below, providing to the user, within a graphical user interface, suggested matches between source data columns and target data columns can facilitate more a more streamlined user experience to allow the user to more easily ingest data from data files into the target database.

In some embodiments, the graphical user interface allows user to input selections of target data columns for source data columns. In particular, an input that selects a graphical representation corresponding to a first target data column from the one or more selected target data columns can be received in the graphical user interface. In response to receiving the user input, a data table can be generated for storing the plurality of source data columns. The data table can be generated to transform the data schema of the data file into the target data schema of the target database such that the source data column corresponds to the first target data column selected by the user. Once the source data columns are stored in the generated data table, the data table can be loaded into the target database and data ingestion of the data file can be successfully completed.

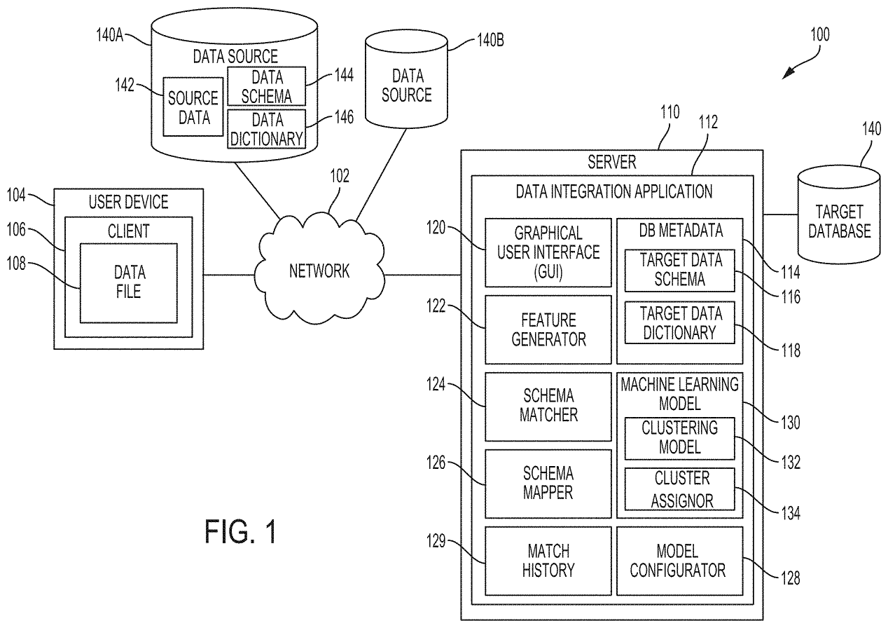

FIG. 1 illustrates a system 100 for automatically ingesting data from disparate data sources 140A-B into a target database 130, according to some embodiments. System 100 includes a network 102 communicatively coupling a user device 104, a server 110, and data sources 140A-B. Network 102 can include wired and/or wireless networks that span a wide area network (WAN) such as the Internet, an intranet, a local area network (LAN), a metropolitan area network (MAN), etc. Network 102 may use any of a plurality of communications standards, protocols, and technologies, including but not limited to Global System for Mobile Communications (GSM), Enhanced Data GSM Environment (EDGE), long term evolution (LTE), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), Wi-MAX, etc.

In some embodiment, data sources 140A-B represent disparate sources of data, which may be managed by different entities (e.g., corporations or users). Data source 140A can include source data 142, data schema 144, and data dictionary 146, according to some embodiments. Each of data sources 140A-B may include similar components. In some embodiment, source data 142 can include a set of data elements (e.g., values) stored in one or more tables. A table can be a data structure having one or more vertical columns (identifiable by name) and one or more horizontal rows where the intersections between the columns and rows are referred to as cells. Each cell can store one data element from the set of data elements.

In some embodiments, data schema 144 (i.e., also referred to as database schema) can include information that defines the data structures (e.g., one or more tables) for storing source data 142. For example, when the data structures include a table, such information may specify a plurality of source data columns in the table along with the data type, constraints, and/or relational information of each source data column.

In some embodiments, data dictionary 146 can include a reference to and a description of the data structures, as defined in data schema 144, for storing source data 142. In some embodiments, these descriptions can include the data column names, data column types, data column descriptions etc. of data in data source 140A. In some embodiments, data dictionary 146 includes a column description of each source data column for each table in data source 140. A column description for a source data column may include human-readable text that describes a purpose of that source data column or what type of data is being stored or is to be stored in that source data column. In some embodiments, data dictionary 146 includes data schema 144.

In some embodiments, user device 104 includes a client 106 configured to access server 110 through network 102. For example, client 106 may be a web browser (e.g., CHROME, IE, SAFARI, etc.) or a client application capable of interfacing with server 110 via network 102. In some embodiments, client 106 can provide a graphical user interface (GUI) to a user that enables the user to request server 110 to ingest data of a data file 108 into target database 130 managed by server 110. In some embodiments, client 106 can be configured to enable the user to upload data file 108 to server 110. In some embodiments, client 106 may enable the user to select a reference to data file 108 already uploaded to server 110. In some embodiments, user device 104 can be a computing device operated by the user and capable of accessing network 102. For example, user device 104 may include a workstation, a desktop computer, a laptop, a tablet, a mobile device such as a smartphone, etc.

In some embodiments, data file 108 can include a portion of or the entirety of source data 142 from a data source such as data source 140A. In some embodiment, data file 108 may include data schema 144 and data dictionary 146 associated with source data 142. Data file 108 may be provided in various data formats such as a database file, a csv file, an Excel file, an XML file, etc.

In some embodiments, server 110 can be a part of a database management system (DBMS) configured to allow the user operating user device 104 to interface with target database 130. In some embodiments, server 110 can be implemented on one or more virtual machines, servers, hardware appliance, general-purpose computers, or a combination thereof.

In some embodiments, to automatically ingest and integrate data from source data file 108 into target database 140, server 110 can include a data integration application 112. In some embodiments, data integration application 112 can be implemented as a plug-in to be integrated within a DBMS or an extract, transform, and load (ETL) process of the DBMS.

As described above, the ingestion and integration process includes schema matching between data source file 108 and target database 130. Target database 140 may represent a “master” database in which data (e.g., in data source file 108) from disparate data sources 140A-B are to be stored in a consistent data structure such that data from disparate data sources 140A-B can be comparable and analyzed. In some embodiments, to maintain this consistent data structure for target database 140, data integration application 112 can store database (DB) metadata 114 including target data schema 116 and target data dictionary 118. In some embodiments, database metadata 114 may be stored and managed by other components of server 110. In these embodiments, data integration application 112 can be configured to interface with these other components to access database metadata 114.

In some embodiments, similar to the functionality of data schema 144 for data file 108, target data schema 116 (e.g., also referred to as target database schema) can include information that defines the data structures (e.g., one or more tables) for storing data in target database 140. For example, this information may specify tables for storing data along with types of target data columns and related information within each table.

Likewise, target data dictionary 118 may serve a similar functionality as data dictionary 146. In some embodiments, target data dictionary 118 can include a reference to and a description of the data structures, as defined in target data schema 116, for storing data in target database 140. In some embodiments, data in target database 140 can be stored in tables. In these embodiments, target data dictionary 118 can include a reference to each target data column of each table in target database 140 as well as a target data column description for each target data column. The target data column description for a target data column may include human-readable text that describes a purpose of that target data column or what type of data is being stored or is to be stored in that target data column. In some embodiments, target data dictionary 118 includes target data schema 114.

In some embodiments, as part of matching data schema 144 of data file 108 to target data schema 116 of target database 140 in order to ingest data from data file 108, data integration application 112 can suggest one or more target data columns for matching each source data column of source data file 108 based on at least two of three sources of information associated with source data file 108. In some embodiments, for each source data column, these three sources of information can include a column header (i.e., a name of the source data column), data within the source data column (e.g., content from a plurality of cells of the source data column), and information in a data dictionary (e.g., a column description of the source data column).

In some embodiments, to obtain and analyze two or more of these three sources of information to ingest data file 108, data integration application 112 can be configured to include the following components: database metadata 114 (as discussed above), graphical user interface (GUI) 120, feature generator 122, schema matcher 124, schema mapper 126, machine learning model 130, model configurator 128, and match history 129. In some embodiments, each component may include a set of programming instructions stored in memory of server 110 and executable by one or more processors of server 110.

In some embodiments, machine learning model 130 includes clustering model 132 and cluster assignor 134. In some embodiments, clustering model 132 can be configured to store associations between a plurality of cluster identifiers (IDs) and the plurality of target data columns specified in target data schema 116. In some embodiments, clustering model 132 stores references to one or more target data columns associated with each cluster ID of the plurality of cluster IDs. Clustering model 132 may store these associations in a data table, a dictionary, or other data structures.

In some embodiments, each cluster ID corresponds to a set of features that describe the data contents stored in the one or more target data columns associated with that cluster ID. For example, one cluster ID may be associated with a plurality of target data columns that each include many cells storing a dollar symbol (e.g., “$”), no alphabetic characters, and seven digits (e.g., “1,000,000.”) Such target data columns may be related to currency such as a company's revenue, a real-estate transaction, etc. In contrast, another cluster ID may be associated with a plurality of target data columns that each include many cells storing a dollar symbol (e.g., “$”), no alphabetic characters, and five digits (e.g., “70,000.”) Such target data columns may be related to currency such as an employee's salary, which is typically below six digits (e.g., “100,000”).

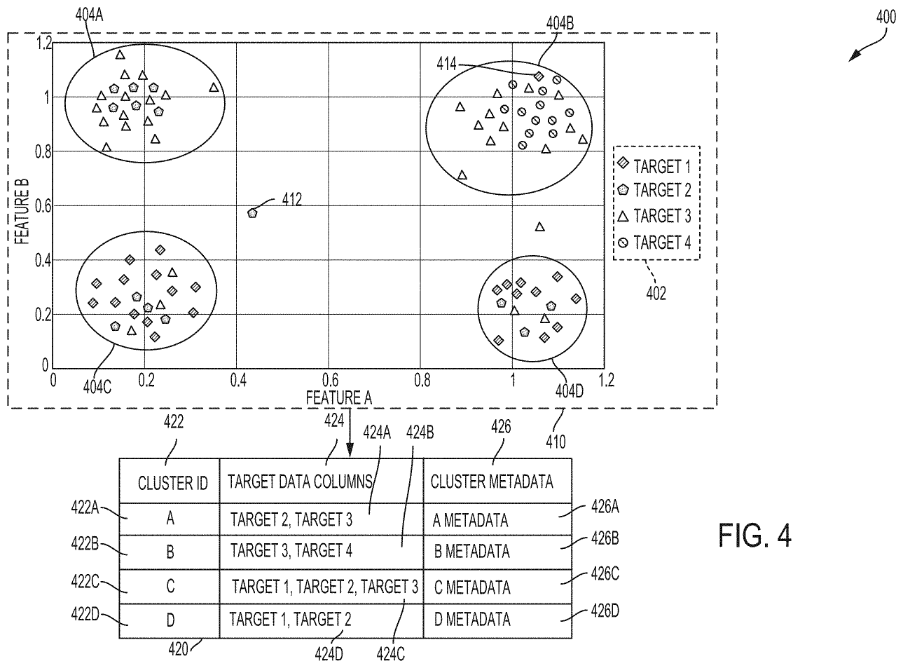

In some embodiments, the plurality of cluster IDs and associations to one or more target data columns can be determined based on a training dataset generated from a dataset provided or selected by the user via GUI 120, as will be further described below with respect to FIG. 4. For example, the dataset may include data selected from target database 140.

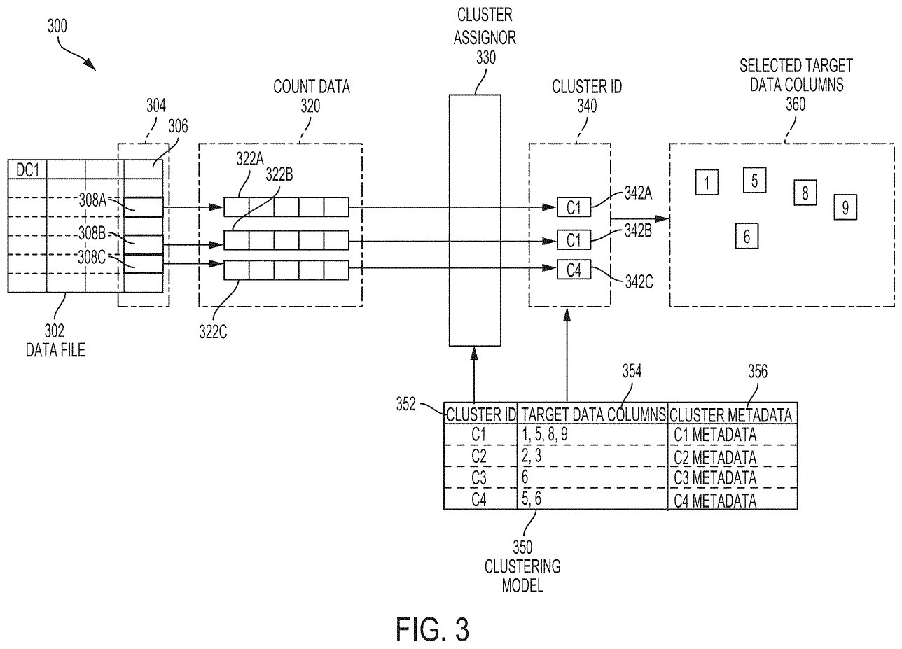

In some embodiments, cluster assignor 134 can be configured to assign a cluster ID to each cell based on a plurality of count data provided for each cell and based on clustering model 132, as will be further described below with respect to FIG. 3. In some embodiments, the cluster ID can be selected from the plurality of cluster IDs stored in clustering model 132. As part of analyzing the data content of a source data column of data file 108, cluster assignor 134 can analyze the plurality of count data for a cell and the cluster metadata stored in clustering model 132 to assign a cluster ID to each cell of a plurality of cells selected from the source data column. Based on the cluster IDs assigned by cluster assignor 134 to the plurality of cells, data integration application 112 can be configured to filter the number of target data columns specified in target data schema 116 and analyze only a subset of the target data columns as possible matches to the source data column, as will be further described below.

In some embodiments, data integration application 112 can receive, from the user operating user device 104, source data file 108 having data to be ingested into target database 140. In some embodiments, data integration application 112 (e.g., GUI 120) can receive the user's selection of data file 108 previously uploaded to server 110. In some embodiments, the schema matching process includes determining at least one target data column as specified in target data schema for matching each source data column in data file 108. As discussed above, however, target database 140 often include thousands or more of target data columns, which makes selecting possible matching target data columns difficult. Accordingly, to filter the number of possible target data columns to analyze for each source data column, data integration application 112 can analyze data content within the source data column.

In some embodiments, data content within the source data column can include information that can be used to match the source data column with one or more target data columns in target schema 114. For example, a source data column having a column header of “ADDRESS” may contain door numbers, street names, and city names, even though the column header does not include those particular words (e.g., “door,” “street,” or “city”). The information related to door numbers, street names, and city names, etc. may be used by data integration application 112 to reduce the number of target data columns of target data schema 116 as potential matches to the source data column regardless of how the source data column is named (i.e., the column header).

In some embodiments, to extract information from the data content of the each source data column, feature generator 122 can be configured to randomly select a plurality of cells from each source data column. In some embodiments, feature generator 122 can be configured to randomly select a plurality of rows from a data table of source data file 108, which corresponds to the plurality of cells randomly selected for each source data column. In some embodiment, the number of randomly selected rows or cells can be a predetermined number (e.g., 1000). In some embodiments, randomly sampling cells or rows of data file 108 allows the sampled data content to be representative of the data of source data column as a whole without requiring each cell of the source data column to be analyzed. Accordingly, this randomly sampling technique can reduce the processing time and memory needed by data integration application 112 to extract information from the data content of each source data column.

In some embodiments, for each selected cell, feature generator 122 can calculate a plurality of count data where each count datum includes a number of occurrences of a characteristic detected in each cell. In some embodiments, the plurality of count data can include character-based features or semantic-based features, each of which include information describing a characteristic of the type of data present in the cell.

In some embodiments, character-based features include the occurrences of specific types of characters that are detected in the data within the cell. In some embodiments, character-based features include one or more of: a number of alphabetical characters in the cell, a number of digits in the cell, a number of white spaces in the cell, a number of special characters in the cell, or a number of total characters in the cell. For example, in a cell of “A1000BC10,” the character-based features may include an alphabet count of three (i.e., A, B, and C), a numeric count of six (i.e., two 1's and four 0's), and a total character count of nine.

In some embodiments, the character-based features can be one source of information for matching the source data column with one or more of the target data columns specified in target data schema 116. For example, a source data column for storing currency information is likely to store the dollar symbol (i.e., “$”) in its cells. In some embodiments, capturing the count of special characters such as the dollar symbols in a cell of the source data column can enable data integration application 112 to determine that the source data column is likely a currency data column. Accordingly, instead of analyzing the plurality of target data columns of target database 140 to determine possible matches to the source data column, data integration application 112 can filter the plurality of target data columns and analyze a subset of the plurality of target data columns related to currency.

In some embodiments, semantic-based features include the occurrences of specific types of semantic information that are detected in the data within the cell. In some embodiments, semantic-based features include one or more of: a number of people names identified in the cell, a number of location names identified in the cell, a number of nouns identified in the cell, a number of verbs identified in the cell, or a number of cardinal numbers identified in the cell.

In some embodiments, to generate the semantic-based features, feature generator 122 can be configured to implement Named Entity Recognition (NER) and Part of Speech Tagging (POS) mechanisms to identify the types of entities or verbiage included within each cell. For example, for a cell of “Jim bought 300 shares of Acme Corp. in 2006,” feature generator 122 may tag: “Jim” with an NER tag of “PERSON”, “Acme Corp.” with an NER tag of “ORGANIZATION”, and “2006” with an NER tag of “OTHER.” Additionally, each word of that cell may be assigned a POS tag representing a part of speech such as one of a noun, verb, article, adjective, preposition, pronoun, adverb, conjunction, and interjection. For example, “Jim” may be tagged with a POS tag of “NOUN” and “bought” may be tagged with a POS tag of “VERB.” In some embodiments, upon tagging the entities or verbiage in the cell, feature generator 122 can be configured to count the number of occurrence of each type of semantic information.

In some embodiments, schema matcher 124 can be configured to select one or more target data columns from target data schema 114 as possible matches for each source data column of data file 108 based on the data contents of each source data column. In some embodiments, the data content for each source data column include a plurality of cells of each source data column from which a plurality of count data describing cell contents is generated for each cell. In some embodiments, to reduce the number of target data columns to be analyzed as possible matches to a source data column, schema matcher 124 can be configured to input the plurality of count data for each cell to cluster assignor 134 of machine learning model 130. As described above, based on the plurality of count data for each cell, cluster assignor 134 can be configured to output a cluster ID for that cell identifying a cluster associated with that cell based on the clustering model 132.

In some embodiments, schema matcher 124 can be configured to select a first set of data columns from target data schema 116 as possible matches to the source data column based on clustering model 132 and one or more cluster IDs assigned to the plurality of selected cells of the source data column. In some embodiments, schema matcher 124 can determine the first set of data columns based on the associations between cluster IDs and target data columns stored in clustering model 132. For example, schema matcher 124 may query clustering model 132 for the one or more target data columns associated with each of the one or more cluster IDs. The first set of data columns may include unique target data columns from the one or more target data columns associated with each of the one or more cluster IDs.

In some embodiments, schema matcher 124 can be configured to select a second set of data columns from the first set of data columns as possible matches to the source data column based on the column header of the source data column. In some embodiments, the column header for the source data column identifies the source data column and includes information regarding the nature or the purpose of the source data column. For example, a column named “JOINING DATE” may provide two pieces of information: the source data column includes date values, and the source data column is used to track the starting date of an employee.

In some embodiments, to filter and reduce the number of target data columns in the first set of data columns, schema matcher 124 can be configured to perform fuzzy string matching between a source column header of the source data column and a target column header of each target data column of the first set of data columns. In some embodiments, fuzzy string matching is a method of performing string operators on a first string (e.g., a target column header) to transform the first string into a second string (e.g., the source column header). In some embodiment, for each pair of source column header and each target column header, schema matcher 124 can be configured to perform fuzzy string matching to generate a string-match score corresponding to a number of string operations to transform the source column header into the target column header or vice versa. In some embodiments, each string operator can be one of: insertion of a character, removing a character, substituting a character, or transposing a character.

For example, an example source column header may be “Thursday” and an example target column header may be “Tuesday.” In this example, schema matcher 124 may generate a string-match score of “2” for the target column header of “Tuesday” because it takes exactly two string operations (i.e., an insert “H” operation and a replace “E” with “R” operation) to derive the source column header of “Thursday.” In another example, the source column header may be “Job Role” and the target column header may be “Job Title.” In this example, schema matcher 124 may generate a string-match score of “3” for the target column header of “Job Title” because it takes exactly three string operations (i.e., a substitute “R” operation, a substitute “0” operation, and a remove “T” operation) to derive the source column header of “Job Role.”

In some embodiments, although the naming conventions of column headers varies from database to database, database designers commonly name column names to capture the purpose of that column, which may result in similar names. For example, as described above, a data column for storing an employee's role may be labeled “Job Title” or “Job Role.”

In some embodiments, schema matcher 124 can be configured to select the second set of data columns from the first set of data columns based on the string-match score generated for each target data column of the first set of data columns. In some embodiments, schema matcher 124 can be configured to select a predetermined number of target data columns from the first set of data columns. In some embodiments, schema matcher 124 can be configured to select target data columns having corresponding string-match scores that fall below a threshold score. Therefore, rather than running fuzzy string matching on the entire set of target data columns in target schema 114, schema matcher 124 can be configured to perform fuzzy string matching on the reduced first set of data columns to further reduce the number of target data columns as possible matches to the source data column.

In some embodiments, schema matcher 124 can be configured to select a third set of data columns from the second set of data columns as possible matches to the source data column based on information in data dictionary 146 including a column description of the source data column. In some embodiments, the column description for the source data column can include free-flowing text that captures the purpose and nature of that source data column beyond that provided by the column header.

In some embodiments, to select the third set of data columns, schema matcher 124 can be configured to compare the column descriptions of each of the second set of data columns with the column description of the source data column. In some embodiments, schema matcher 124 can retrieve the column description for each target data column in the second set of data columns based on target data dictionary 118, which stores a column description for each target data column of target database 140.

In some embodiments, to compare the column descriptions, schema matcher 124 can be configured to vectorize each target column description in target database 140 for storage in database metadata 114 (e.g., in target data schema 116 or in target data dictionary 118). In some embodiments, vectorization of each column description allows vector operations (such as addition or distance calculation) to be performed on the column descriptions.

In some embodiments, database metadata 114 stores a target vector for each target data column of target database 140. In some embodiment, vectorization of a target column description of a target column involves converting the free-flowing text (in the target column description) into the target vector including an array of numbers that captures the semantic and syntactic information in the free-flowing text. The vectorization process is a type of lossy compression of the text. In some embodiments, schema matcher 124 performs the vectorization based on one or more sentence vectorization algorithms such as a skip-thoughts model, gensim doc2vec, or paragram embeddings.

In some embodiments, to compare the column descriptions between the source data column and the second set of data columns, schema matcher 124 can be configured to generate a source vector based on the column description of the source data column. Then, schema matcher 124 can compare the source vector against the plurality of target vectors corresponding to the second set of data columns to select the third set of data columns. In some embodiments, schema matcher 124 can determine the plurality of target source vectors for the second set of data columns by querying database metadata 114.

In some embodiments, to compare the source vector against the plurality of target vectors, schema matcher 124 can calculate a distance metric between the source vector (corresponding to the source column description) and each of the target vectors of the plurality of target vectors (corresponding to the second set of data columns). In some embodiments, the distance metric (e.g., a Euclidean distance, a cosine similarity, a Pearson correlation, a Minkowsky distance, etc.) between two vectors can be used to quantify a semantic similarity or dissimilarity between two column descriptions. In effect, a smaller distance metric between two vectors may indicate that the two vectors are “closer” to each other in the vector space and are more likely to share common semantic or syntactic information. In some embodiments, schema matcher 124 can be configured to calculate a score for each target vector of the plurality of target vectors where each score is associated with the distance metric calculated between that target vector and the source vector. In some embodiments, schema matcher 124 can be configured to select the third set of data columns from the second set of data columns as having the highest scores (e.g., the lowest distance measures) or having a score above a threshold value.

In some embodiments, schema mapper 126 can be configured to ingest data file 108 in response to receiving, via GUI 120, the user's selection of a target data column for each source data column of data file 108. In some embodiments, schema mapper 126 can be configured to generate a data table that transforms data schema 144 associated with data file 108 to target data schema 116 associated with target database 140 such that the schema of each source data column is mapped to the schema of the target data column selected for that source data column. In some embodiments, schema mapper 126 can store the plurality of source data columns into the generated data table and load the generated data table into target database 140.

In some embodiments, model configurator 128 can be configured to train clustering model 132 based on a training dataset. In some embodiments, the training dataset may be generated based on data selected from target database 140. In some embodiments, the data for training machine learning model 130 can be selected by a user associated with target database 140 such as database administrators. In some embodiments, this user may be the same or different from the user operating user device 104.

In some embodiments, to generate the training dataset, model configurator 128 can be configured to generate a plurality of count data for each cell of a plurality of cells of each target data column in the selected data, e.g., data tables of target database 140. In some embodiments, the plurality of cells for a target data column may correspond to a predetermined number of cells selected from the target data column, a predetermined percentage of cells randomly selected from the target data column, or all of the cells in the target data column. In some embodiments, model configurator 128 can request feature generator 122 to generate the plurality of count data for each cell.

In some embodiments, model configurator 128 can be configured to execute an unsupervised, clustering learning algorithm on the plurality of count data for each cell to generate a plurality of clusters with each cluster being assigned a cluster ID. Examples of clustering learning algorithms executed by model configurator 128 may include K-means clustering algorithm, agglomerative clustering, or fuzzy clustering, etc.

In some embodiments, each cluster includes one or more cells from one or more target data columns, as will be further described below with respect to FIG. 4. In some embodiments, model configurator 128 can be configured to augment the training dataset to include a cluster ID assigned by the clustering learning algorithm to each cell. In some embodiments, model configurator 128 can determine the one or more target data columns to associate with each cluster ID based on the cells assigned to that cluster ID. In some embodiments, model configurator 128 can store these associations in clustering model 132.

In some embodiments, model configurator 128 can determine the number of clusters of the plurality of clusters based on the clustering result of the clustering learning algorithm. In some embodiments, model configurator 128 can be configured to generate and store cluster metadata for each of the clusters in clustering model 132 based on the augmented training dataset. For example, such cluster metadata for a cluster may include information differentiating that cluster from the other clusters. In some embodiments, upon training clustering model 132, cluster assignor 134 can be configured to use clustering model 132 to select a cluster ID from a plurality of cluster IDs corresponding to the plurality of clusters for each cell based on the plurality of count data for that cell, as described above.

In some embodiments, model configurator 128 can be configured to generate a training dataset to update machine learning model 130 based on user inputs received in GUI 120, will be further described below.

In some embodiments, graphical user interface (GUI) 120 can be configured to provide a GUI to the user to enable the user to more easily ingest and integrate data from source data file 108 into target database 140, as will be further described below. In some embodiments, GUI 120 can be configured to display to the user one or more graphical representations corresponding to one or more target data columns, as determined by schema matcher 124, for each source data column of source data file 108. In some embodiments, GUI 120 may allow the user to select a graphical representation of a target data column from the displayed graphical representations or to enter a different target data column for each source data column. In some embodiments, GUI 120 may receive a confirmation from the user after the user has selected a target data column to match each source data column. In some embodiments, after receiving the user's confirmation, GUI 120 can be configured to request schema mapper 126 to perform schema mapping to ingest the data of data file 108 into target database 140, as described above.

In some embodiments, match history 129 stores associations between the user's target data column selections for data file 108 and a schema ID associated with data file 108. In some embodiments, to generate the schema ID for data file 108, data integration application 112 can be configured to hash a plurality of header columns corresponding to the plurality source data columns in data file 108. For example, the schema ID may be the generated hash. In some embodiments, by storing these user selections in match history 129, data integration application 112 can provide one or more target data columns that are more likely to match a source target data column for a future data file having the same data schema 144 as data file 108.

In some embodiments, to determine if the future data file has the same data schema 144 as data file 108, data integration application 112 can generate a hash of a plurality of header columns corresponding to a plurality of source data columns of the future data file. Then, data integration application 112 may query match history 129 for a schema ID corresponding to the generated hash to determine if the schema of the future data file has been previously encountered. If such a schema ID is identified, data integration application 112 may provide the user selections associated with that schema ID as possible target data columns matching the source data columns of the future data file.

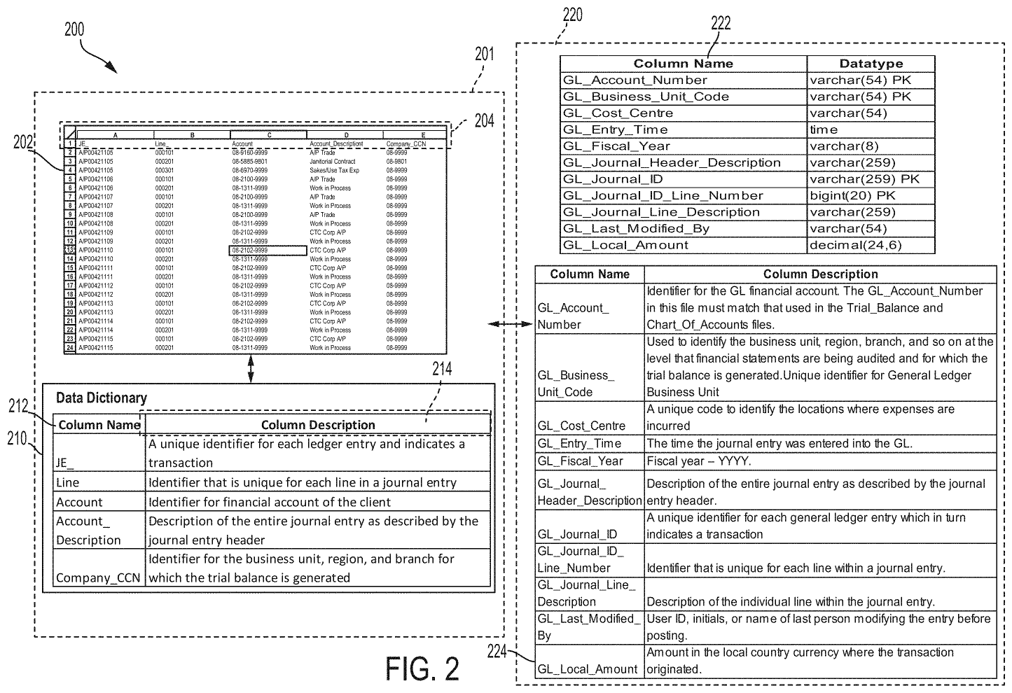

FIG. 2 illustrates a diagram 200 showing an example data file 201 to be ingested into a target database 220 associated with an example target data schema 222 and a target data dictionary 224, according to some embodiments. In some embodiments, data file 201 and target data schema 222 may correspond to data file 108 and target data schema 116 of target database 130, respectively, of FIG. 1. Likewise, target data dictionary 224 may correspond to target data dictionary 118 of FIG. 1. As shown in diagram 200, data file 201 may include a dataset 202 and a data dictionary 210.

Dataset 202 can include data from a data source such as data source 140A of FIG. 1. For example, dataset 202 may include a data table having a plurality of source data columns 204 with each data column having a plurality of cells for storing data. In the example shown in diagram 200, dataset 202 may be stored in an Excel file and include source data columns such as “JE_”, “Line,” “Account,” “Account Description,” and “Company_CCN.” Data dictionary 210 can include information 214 describing each data column 212 of data columns 204 in dataset 202. For example, as shown in diagram 200, such information 214 may include a column description (i.e., “Description”). Other examples of information 214 for each data column 212 may include, without limitation, a column header (i.e., “Field Name”), a column description (i.e., “Description”), a column data type (i.e., “Type”), or a detailed column data type (i.e., “Specifications”), etc.

As described above, users such as data integration engineers often need to ingest dataset 202 having data described by data dictionary 210 into the target database 220 as organized and defined by target data schema 222 and described in target data dictionary 224. As shown in diagram 200, target data schema 222 may specify a plurality of target data columns in target database 220. However, none of the target data columns have the same name as the source data columns. In order to assist users in ingesting and integrating dataset 202 into the target database, a data integration application, such as data integration application 112 of FIG. 1, can be configured to suggest possible matches between source data columns 204 and the target data columns in target data schema 222 based on extracting three types of information for each of source data columns 204. In some embodiments, these three types of information may include a plurality of cells selected from a source data column, a column header of the source data column, and a column description of the source data column. For example, the data integration application may compare the column descriptions of a source data column in data dictionary 210 with column descriptions of target data columns in target data dictionary 224 to select one or more target data columns that likely match the source data column. For example, based on at least two of the three types of information, the data integration application may select the target data column of “GL_Journal ID” from target data schema 222 as a possible match to the source data column of “JE_” in dataset 202. In another example, based on, for example, column descriptions, the data integration application may select the target data column of “GL_Business_Unit_Code” from target data schema 222 as a possible match to the source data column of “Company_CCN.”

FIG. 3 illustrates a diagram 300 showing how one or more target data columns 360 are selected as possible matches for a source data column 304, according to some embodiments. In some embodiments, diagram 300 graphically illustrates the selection process performed by data integration application 112 of FIG. 1.

As shown in diagram 300, data file 302 (e.g., data file 108) may include a plurality columns and each column may include a plurality of cells storing data from a data source (e.g., data source 140A). In some embodiments, data file 302 may be selected by a user for ingesting into a target database (e.g., target database 130). In some embodiments, the target database may be structured according to a target data schema (e.g., target data schema 116) that specifies a plurality of target data columns in the target database. In typical operation, the plurality of target data columns may number in the thousands or more. Typically, a user interface may enable the user to select one of the target data columns for mapping to, for example, source data column 304. However, the user may need to scroll through thousands of target data columns, which increases time and user error.

In some embodiments, for source data column 304, feature generator 122 can randomly select and analyze a plurality of cells 308A-C of data source column 304 to select target data columns 360 for matching to source data column 304. For example, a predetermined amount (e.g., 3) of cells may be randomly selected.

In some embodiments, feature generator 122 can calculate count data 322A-C corresponding to cells 308A-C. As shown in diagram 300, cluster assignor 330 (e.g., cluster assignor 134) can be configured to assign cluster IDs 342A-C for corresponding cells 308A-C based on corresponding count data 322A-C and based on clustering model 350. For example, cluster assignor 330 may assign cell 308A as belonging to cluster ID 342A (“C1”) based on count data 322A. In some embodiments, as described above with respect to FIG. 1, clustering model 350 may store cluster metadata 356 associated with each of cluster IDs 352. For example, cluster metadata 356 may include information characterizing a cluster ID (e.g., centroid information when clustering model 350 is generated based on a k-means clustering algorithm). By analyzing the plurality of count data for a cell with respect to cluster metadata 356, cluster assignor 330 can be configured to select cluster ID 342A as being most similar to that cell.

In some embodiments, schema matcher 124 can select the one or more target data columns 360 based on cluster IDs 342A-C and clustering model 350 (e.g., clustering model 132). As described with respect to FIG. 1, clustering model 350 may store one or more target data columns 354 associated with each cluster ID 302. For example, cluster “C1” may be stored in association with references to target data columns 1, 5, 8, and 9. In some embodiments, target data columns 360 can include unique target data columns from target data columns 354 associated with cluster IDs 342A-C. For example, as shown in clustering model 350, cluster ID 342A of “C1” is associated with target data columns 1, 5, 8, and 9, and cluster ID 342C of “C4” is associated with target data columns 5 and 6. In this example, target data columns 360 may include target data columns 1, 5, 6, 8, and 9.

FIG. 4 illustrates a diagram 400 showing how a clustering model 420 is generated, according to some embodiments. In some embodiments, clustering model 420 (e.g., clustering model 132) can be generated based on a training dataset generated from data of a target database (e.g., target database 140). In some embodiments, as described above with respect to model configurator 128 of FIG. 1, the dataset from the target database may include a plurality of target data columns 402 each having a plurality of cells.

To generate the training dataset for configuring clustering model 420, model configurator 128 can be configured to generate a plurality of count data for each cell of a plurality of cells of each of target data columns 402. In some embodiments, model configurator 128 can run an unsupervised clustering algorithm on the plurality of count data for each cell to group the plurality of cells from target data columns 402 into a plurality of clusters 404A-D as shown in graph 410. Example graph 410 shows that features A and B (e.g., corresponding to the plurality of count data) for each cell can be used by the clustering algorithm to cluster the cells. In some embodiments, cells having similar data characteristics will be grouped into the same cluster.

In some embodiments, as shown in diagram 400, the cells from each of target data columns 402 can be clustered into one or more of clusters 404A-D. Accordingly, each of clusters 404A-D may include cells from two or more target data columns 402 due to the data similarities between these target data columns. For example, cluster 404B may be associated with cells having thirteen digits and, therefore, may include cells from an account number data column with thirteen digits (e.g., “Target 3”) and a timestamp data column with thirteen digits (e.g., “Target 4”). Based on similar logic, by clustering on the individual cells of each of target data columns 402, the same target data column may be part of two or more of clusters 404A-D, which accounts for the variations that may be present in the cells for that target data column. For example, a date data column may include cells with a format of “dd-mm-yy” or with a timestamp format with thirteen digits (e.g., 1533126058528). Therefore, depending on the type of data format for the date data column, the cells in this date data column may be clustered into a first cluster associated with format “dd-mm-yy” or a second cluster associated with fifteen digits.

In some embodiments, model configurator 128 can be configured to determine the number of clusters 404A-D to configure clustering model 420 by using methods such as Silhouette score. In the Silhouette score method, model configurator 128 can measure and compare a cell's similarity to those in its own cluster as well as those in other clusters to determine whether the number of clusters 404A-D accurately capture the data characteristics of the plurality of cells in the training dataset.

In some embodiments, model configurator 128 can assign a cluster ID corresponding to one of clusters 404A-D to each cell of each of target data columns 402 based on the cluster in which the cell is grouped. For example, cell 414 from target data column 1 is assigned to cluster ID “B” corresponding to cluster 404B. In some embodiments, some cells such as cell 412 from target data column 2 may not be assigned to any cluster IDs because it may be an outlier and does not have features similar to that of other cells in clusters 404A-D.

In some embodiments, model configurator 128 can be configured to store associations between cluster IDs 422 and one or more target data columns 424 based on the cells in each of clusters 404A-D. In some embodiments, model configurator 128 can select the one or more target data columns 424 associated with a cluster ID 422 based on a proportion or a number of the cells in the cluster being from one of target data columns 402. For example, cluster 404B may have: 1 cell from “Target 1”, 12 cells from “Target 3”, and 12 cells from “Target 4”. As shown in clustering model 420, however, cluster ID 422B assigned to cluster 404B may include only target data columns 424B of “Target 3” and “Target 4” because the 1 cell from “Target 1” falls below a threshold value or is associated with a proportion of cells (e.g., 1/25=4%) in cluster 404B that falls below a threshold value (e.g., 20%). Each of the one or more target data columns 424A-D for corresponding cluster IDs 422A-D may be similarly selected.

Model configurator 128 may augment the training dataset to include one of cluster IDs 422 assigned to each cell in the training dataset. Then, model configurator 128 may further configure clustering model 420 based on the augmented dataset. In some embodiments, model configurator 128 can determine and store cluster metadata 426A-D for corresponding cluster IDs 422A-D. In some embodiments, cluster metadata 426 may include information that characterizes the associated cluster ID that differentiates it from the other cluster IDs. In some embodiments, cluster metadata 426 may be used by cluster assignor 314 to assign the same cluster ID to cells sharing similar data characteristics. Accordingly, cluster assignor 134 may predict the clustering behavior of cells having data types that were encountered in the training dataset during the training phase. In some embodiments, however, cluster assignor 134 may not extrapolate clustering behaviors from cells with data types that have not been previously analyzed in the training dataset of the training phase. To address this drawback, model configurator 128 can be configured to periodically or on-demand retrain clustering model 420 based on new data files that have been ingested into the target database since the last time that clustering model 420 has been configured. By retraining clustering model 420, cluster assignor 314 can improve its accuracy in assigning cluster IDs to cells.

In some embodiments, the retraining process using new data files involves the same methods of generating and processing a training dataset, as described above. In these embodiments, the old data in the target database may be included with new data in the new data files to generate the training dataset. Due to the data characteristics and formats introduced by the cells in these new data files, however, the clustering algorithm may generate different clusters than clusters 404A-D based on different combination of features (i.e., count data) present in these new data files and the one or more target data columns associated with each cluster may also be different than that of clustering model 420.

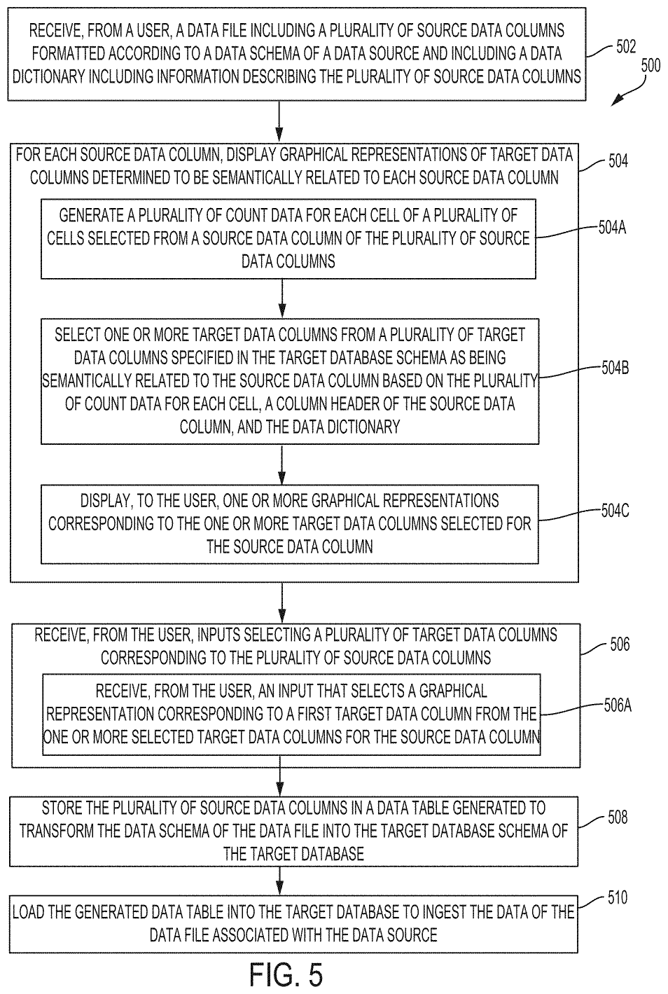

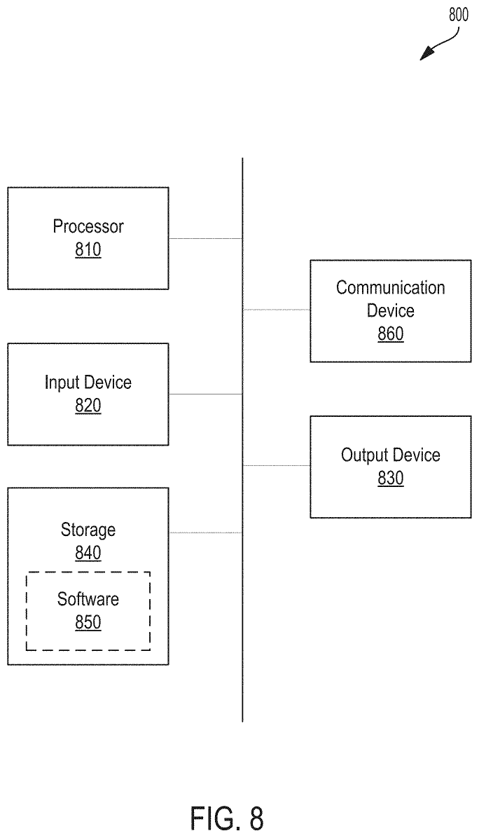

FIG. 5 illustrates a method 500 for automatically ingesting data from disparate data sources into a target database, according to some embodiments. Method 500 can be performed by a data integration application such as data integration application 112 of FIG. 1. Accordingly, one or more of the blocks referenced below may refer to the components of data integration application 112. Method 500 can be a computer-implemented method performed by a computing system with one or more processors and a memory (e.g., the computing system 800 illustrated in FIG. 8). Method 500 may be included in one or more programs stored in memory that, when executed by the one or more processors, cause the one or more processors to perform method 500.

In step 502, a graphical user interface (e.g., graphical user interface (GUI) 120) of the data integration application receives a data file from a user. In some embodiments, the data file includes a plurality of source data columns formatted according to a data schema of a data source and includes a data dictionary (e.g., data dictionary 146) including information describing the plurality of source data columns. In some embodiments, the GUI can be configured to receive and upload the data file provided by the user. In some embodiments, the GUI may receive a user's selection of the uploaded data file whose data is to be ingested into the target database.

In step 504, for each source data column of the data file, the GUI displays graphical representations of target data columns determined to be semantically related to each source data column. In some embodiments, step 504 includes steps 504A-504C that can be performed by the data integration application for each source data column of the data file.

In step 504A, a feature generator (e.g., feature generator 122) of the data integration application generates a plurality of count data for each cell of a plurality of cells selected from a source data column of the plurality of source data columns. In some embodiments, the feature generator can be configured to randomly select a predetermined amount of the cells in the source data column and the plurality of selected cells corresponds to the predetermined amount. In some embodiments, the plurality of count data can include counts of character-based features or semantic-based features, as described above with respect to FIG. 1.

In step 504B, a schema matcher (e.g., schema matcher 124) of the data integration application selects one or more target data columns from a plurality of target data columns specified in the target data schemas being semantically related to the source data column based on the plurality of count data for each cell, a column header of the source data column, and the data dictionary.

In step 504C, the GUI displays, to the user, one or more graphical representations corresponding to the one or more selected target data columns for the source data column.

In step 506, the GUI receives, from the user, inputs selecting a plurality of target data columns corresponding to the plurality of source data columns. In some embodiments, step 506 includes step 506A. In step 506A, the GUI receives, from the user, an input that selects a graphical representation corresponding to a first target data column from the one or more selected target data columns for the source data column described with respect to steps 504A-C.

In step 508, a schema mapper (e.g., schema mapper 126) of the data integration application stores the plurality of source data columns in a data table generated to transform the data schema of the data file into the target data schema of the target database. In some embodiments, the source data column stored in the data table can be stored in a schema of the first target data column described with respect to step 506A.

In step 510, the schema mapper loads the generated data table into the target database to ingest the data of the data file associated with the data source.

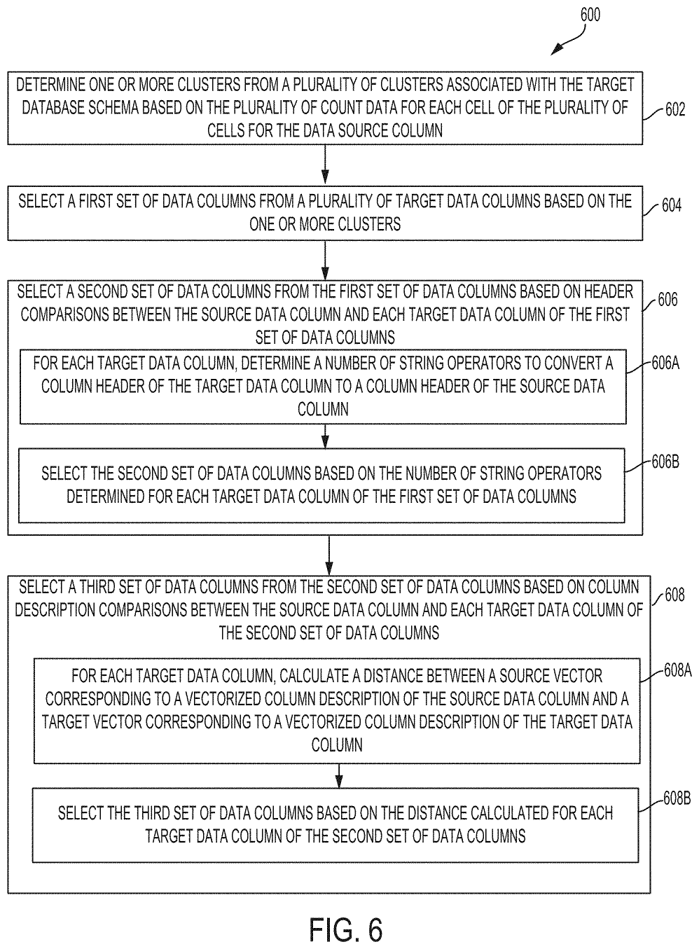

FIG. 6 illustrates a method 600 for automatically selecting one or more target data columns as possible matches for a source data column, according to some embodiments. In some embodiments, method 600 expands upon step 504B, as described above with respect to FIG. 5. Accordingly, for ease of reference, the steps of method 600 below may be described in reference to the components and steps of FIG. 5. Method 600 can be performed by a data integration application such as data integration application 112 of FIG. 1. Accordingly, one or more of the blocks referenced below may refer to the components of data integration application 112. Method 600 can be a computer-implemented method performed by a computing system with one or more processors and a memory (e.g., the computing system 800 illustrated in FIG. 8). Method 600 may be included in one or more programs stored in memory that, when executed by the one or more processors, cause the one or more processors to perform method 600.

In step 602, the schema matcher determines one or more clusters from a plurality of clusters associated with the target data schema based on the plurality of count data for each cell of the plurality of cells for the data source column. In some embodiments, the schema matcher can be configured to assign each cell as belonging to a cluster from the plurality of clusters based on a clustering model, as described above with respect to FIGS. 1 and 3. Then, based on the clusters assigned to the plurality of cells of the data source column, the schema matcher can be configured to determine the one or more clusters.

In step 604, the schema matcher selects a first set of data columns from a plurality of target data columns based on the one or more determined clusters. In some embodiments, the schema matcher can select the first set of data columns based on a clustering model (e.g., clustering model 132) storing associations between each cluster of the plurality of clusters and one or more target data columns. For example, the schema matcher can select the first set of data columns by querying the clustering model based on the one or more determined clusters. In some embodiments, the first set of data columns include references to unique target data columns from target data columns associated with each cluster of the one or more determined clusters.

In step 606, the schema matcher selects a second set of data columns from the first set of data columns based on header comparisons between the source data column and each target data column of the first set of data columns. In some embodiments, the schema matcher can perform the header comparisons based on performing fuzzy string matching, as described above with respect to FIG. 1. In some embodiments, step 606 includes steps 606A-B.

In step 606A, for each target data column, the schema matcher determines a number of string operations to convert a column header of the target data column to a column header of the source data column or vice versa. In some embodiments, each string operation includes one of a character insertion, a character removal, or a character substitution. In some embodiments, each string operation includes one of a character insertion, a character removal, a character substitution, or a character transposition.

In step 606B, the schema matcher selects the second set of data columns based on the number of string operations determined for each target data column of the first set of data columns. In some embodiments, a target data column from the first set of data columns can be selected if a number of string operations for that target data column fall below a threshold value.

In step 608, the schema matcher selects a third set of data columns from the second set of data columns based on column description comparisons between the source data column and each target data column of the second set of data columns. In some embodiments, step 608 includes steps 608A-B.

In step 608A, for each target data column of the second set of data columns, the schema matcher calculates a distance between a source vector corresponding to a vectorized column description of the source data column and a target vector corresponding to a vectorized column description of the target data column. In some embodiments, the column description of the target data column can be determined from a target data dictionary (e.g., target data dictionary 118) and the column description of the source data column can be determined from the data dictionary in the data file. In some embodiments, for each target data column in the target database, the schema matcher can be configured to store a corresponding target vector generated based on vectorizing the column description associated with that target data column, as described above with respect to FIG. 1.

In step 608B, the schema matcher selects the third set of data columns based on the distance calculated for each target data column of the second set of data columns. In some embodiments, the schema matcher can calculate a score for each target data column of the second set of data columns based on the corresponding, calculated distance. The score can be inversely proportional to the distance such that a greater score for a target data column corresponds to a higher likelihood that the target data column is semantically equivalent to the source data column. In some embodiments, the schema matcher can select, from the second set of data columns, a predetermined number of data columns having the highest scores (i.e., having the smallest distances) or data columns having scores that exceed a threshold value (i.e., distances that fall below a threshold value). In some embodiments, the third set of data columns corresponds to the one or more target data columns selected in step 504B of FIG. 5 for the source data column.

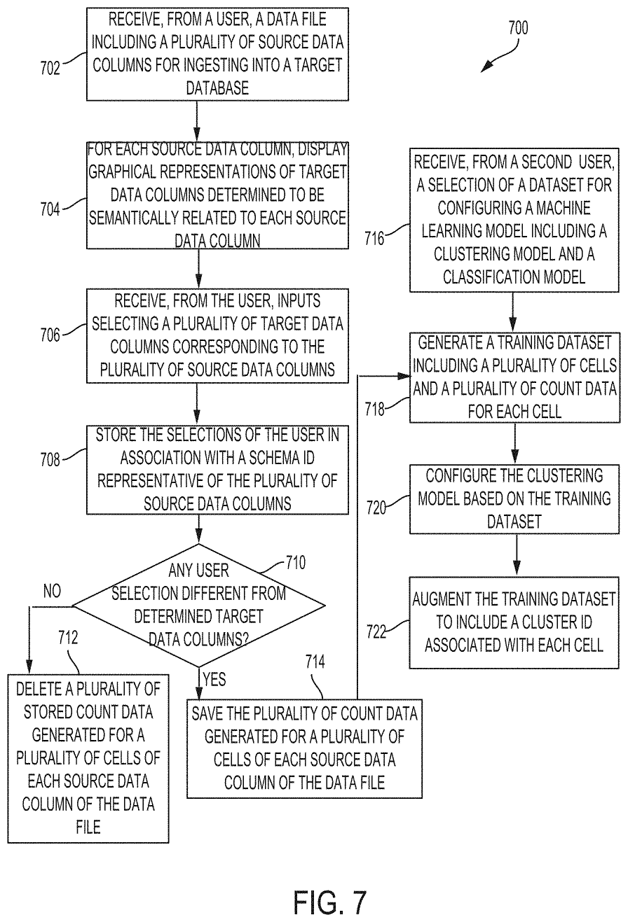

FIG. 7 illustrates a method 700 for configuring a machine learning model to enable automatically ingesting data from disparate data sources into a target database, according to some embodiments. For ease of reference, the steps of method 700 below may be described in reference to diagram 400 as described with respect to FIG. 4. Method 700 can be performed by a data integration application such as data integration application 112 of FIG. 1. Accordingly, one or more of the blocks referenced below may refer to the components of data integration application 112. Method 700 can be a computer-implemented method performed by a computing system with one or more processors and a memory (e.g., the computing system 800 illustrated in FIG. 8). Method 700 may be included in one or more programs stored in memory that, when executed by the one or more processors, cause the one or more processors to perform method 600.

In some embodiments, the machine learning model corresponds to machine learning model 130 of FIG. 1 and includes a clustering model (e.g., clustering model 132) and a cluster assignor (e.g., cluster assignor 134). In some embodiments, configuring the machine learning model includes generating a training dataset to “train” the clustering model of the machine learning model, which enables the operations of the cluster assignor described above in FIGS. 1 and 3. In some embodiments, as shown in method 700, the training dataset can be generated based on a first or a second source of data. In some embodiments, the first source of data can be based on a user's selected dataset, as described below with respect to step 716. In some embodiments, the second source of data can be based on the user's feedback for suggested schema matches of a previously ingested data file, as described below with respect to steps 702-714.

In step 716, a graphical user interface (e.g., GUI 120) of the data integration application receives a selection of a dataset for configuring the machine learning model including the clustering model. In some embodiments, the GUI may receive the selection from a user that manages the target database such as database administrators. This user may be different from the user that initiates data ingestion, as described below with respect to steps 702-714. In some embodiments, the selected dataset may include data from the target database. In some embodiments, the selected dataset may be uploaded by the user.

In step 702, the GUI receives, from the user, the data file including a plurality of source data columns for ingesting into a target database. In some embodiments, step 702 corresponds to step 502 of FIG. 5.

In step 704, for each source data column, the GUI displays, to the user, one or more graphical representations of corresponding target data columns determined to be semantically related to each source data column of the plurality of source data columns. In some embodiments, step 704 corresponds to step 504 of FIG. 5. In some embodiments, to determine the one or more target data columns for each source data column, a feature generator (e.g., feature generator 122) can be configured to generate a plurality of count data for a plurality of cells randomly selected from each source data column, as described above with respect to FIGS. 1, 3, and 5. The plurality of count data for each cell can be used by the data integration application to filter possible target data columns for matching to each source data column.

In step 706, the GUI receives, from the user, inputs selecting a plurality of target data columns corresponding to the plurality of source data columns. In some embodiments, step 706 corresponds to step 506 of FIG. 5.

In step 708, a schema matcher (e.g., schema matcher 124) of the data integration application stores the selections of the user in association with a schema ID representative of the plurality of source data columns of the data file. In some embodiments, the schema matcher can store the user's selection in association with the schema ID in memory (e.g., match history 129). In some embodiments, the schema matcher can generate the schema ID by hashing a plurality of column headers corresponding to the plurality of source data columns of the data file.

In step 710, for each source data column, the schema mapper determines if the user's selection of a target data column for the source data column is different from the one or more target data columns determined for the source data column in step 704. In other words, the schema mapper can determine if any of the user's selections differs from the one or more target data columns suggested for a source data column. If not, then the one or more target data columns determined for each sourced data column is accurate and method 700 proceeds to 712. If any such difference is detected, method 700 proceeds to step 714.

In step 712, the schema matcher deletes a plurality of stored count data generated for a plurality of cells of each source data column of the data file. In some embodiments, as described above with respect to step 504, the plurality of count data for each cell of the plurality of cells may be used by the schema matcher to select a first set of data columns from a plurality of target data columns of the target database. If schema matcher is accurate, then the plurality of count data does not need to be saved and can be deleted.

In step 714, the schema matcher saves the plurality of count data generated for the plurality of cells of each source data column of the data file. In contrast to step 712, the user's selections in step 710 may indicate that the schema matcher did not accurately determine a target data column to match each source data column of the data file. Therefore, the data file may include data having a new data format or type and should be used to train the machine learning model to improve a future accuracy of the schema matcher.

In step 718, a model configurator (e.g., model configurator 128) generates a training dataset including a plurality of cells and a plurality of count data for each cell. In some embodiments, the model configurator can be configured to generate the training dataset based on a dataset from the target database, as described above in step 718. In these embodiments, to generate the training dataset, the model configurator can select a plurality of cells of each data column of the dataset and generate the plurality of count data for each cell, as described above with respect to FIGS. 1, 2, and 6.

In some embodiments, the model configurator can be configured to generate the training dataset based on the plurality of count data generated for a plurality of cells of each source data column of the source data column, as described above with respect to step 714. In these embodiments, the plurality of count data was previously generated in step 704 and the training dataset may correspond to the plurality of saved count data. In some embodiments, by reconfiguring the machine learning model based on the user's feedback, the data integration application is adaptive to new data types encountered in input data files and future data files having schema similar to that of the data file of step 702 can be matched to a target schema of the target database using the updated, retrained machine learning model.

In some embodiments, the training dataset can be generated based on a combination of the user's selected dataset and the plurality of saved count data previously generated for the data file.

In step 720, the model configurator configures the clustering model based on the training dataset. In some embodiment, the clustering model can be configured according to the process described with respect to FIGS. 1 and 4. In particular, the clustering model may be configured to include a plurality of cluster IDs and include references to one or more target data columns associated with each cluster ID.

In step 722, the model configurator augments the training dataset to include a cluster ID associated with each cell. In some embodiments, after configuring the clustering model, the model configurator can assign each cell of the training dataset with a cluster ID from one of the plurality of cluster IDs stored in the clustering model.

In some embodiments, the model configurator configures the clustering model based on the augmented training dataset, as further described above with respect to FIGS. 1 and 4. For example, the model configurator can be configured to store cluster metadata for each of cluster IDs in the clustering model. The cluster metadata for a cluster ID may include cluster characteristics (e.g., centroid information) of the corresponding cluster that differentiates it from the other clusters. This cluster metadata may be used by a cluster assignor (e.g., cluster assignor 134) to assign cluster IDs to cells of a client file having data to be ingested into the target database.

In some embodiments, the cluster assignor can include a classification mode separate from the clustering model. In these embodiments, the model configurator can configure the classification model based on the augmented training dataset. For example, such classification models may include support vector machines (SVM), decision trees, k-nearest neighbor algorithms, or neural networks, etc.

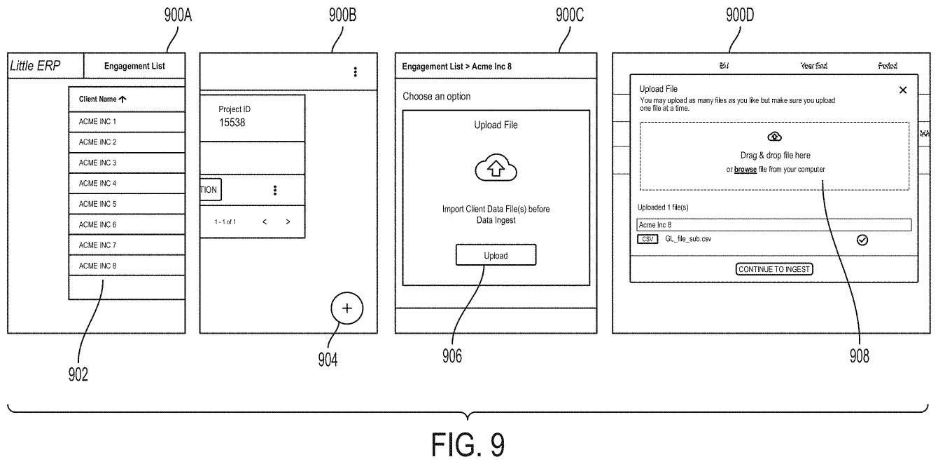

FIGS. 9-12 illustrate GUIs 900-1200 for enabling a user to interact with a data integration application (e.g., data integration application 112) to ingest data from disparate data sources into a target database, according to some embodiments. In some embodiments, GUIs 900-1200 can be provided by a graphical user interface (GUI) 120 of FIG. 1. For ease of references, the following descriptions may refer to the components of FIG. 1.

FIG. 9 illustrates GUIs 900A-D for enabling the user to upload a data file (e.g., data file 108) associated with a data source (e.g., data source 140A), according to some embodiments. In some embodiments, GUI 900A displays a plurality of entities (e.g., company names) from which the user can select, for example, entity 902 whose data is to be ingested and integrated with a target database (e.g., target database 140). As shown in GUI 900B, in response to receiving the user's selection of entity 902, GUI 900B can display information related to the selected entity 902 along with displaying an addition icon 904 that enables the user to upload the data file whose data is to be ingested into the target database.

In some embodiments, in response to receiving the user's selection of addition icon 904, GUI 900C can be configured to display a window that enables the user to upload 906 the data file. As shown in GUI 900D, window 908 allows the user to upload one or more data files, if needed. In some embodiments, in response to receiving the user's selection of the one or more data files, the data integration application can be configured to upload the one or more selected data files. In some embodiments, after the one or more source files have been uploaded, GUI 900D displays a completion icon such as a green check icon.

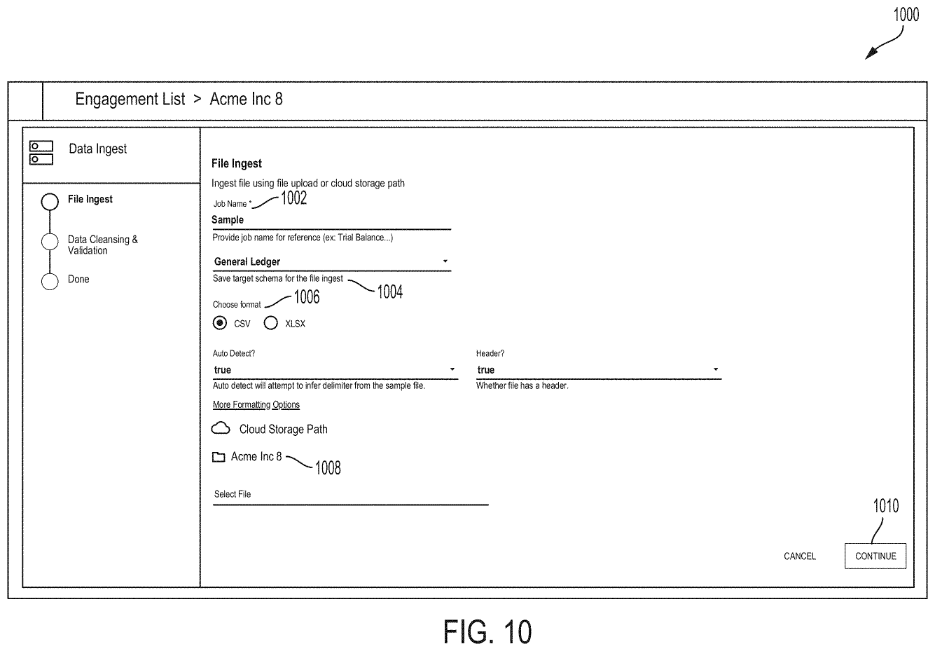

FIG. 10 illustrates a GUI 1000 for enabling a user to request the data integration application to integrate data in the data file with the target database, according to some embodiments. In some embodiments, upon receiving the user's selection of the button to “Continue To Ingest” in GUI 900D, GUI 1000 can be displayed.

In some embodiments, the process for ingesting and integrating the data of the data file with the target database can be referred to as a mapping job. GUI 1000 displays field 1002 that can receive a user's assigned name to the mapping job whose name may be referenced as a line item in a dashboard (not shown) to enable the user to view a status of mapping jobs.

In some embodiments, GUI 1000 displays field 1004 to enable the user to select the target database in which data from the data file is to be ingested. GUI 1000 also displays option 906 that enables the user to select appropriate file format such as CSV or XLSX. In some embodiments, GUI 1000 displays dropdown menu 1008 that enables the user to select one or more previously uploaded data files whose data is to be ingested and integrated with the target database specified by field 1004. In some embodiments, in response to receiving at least one selection of the data file and the target database, GUI 1000 can display selectable button 1010 that upon a user's selection causes the data integration application 112 to proceed with the data ingestion and integration process.

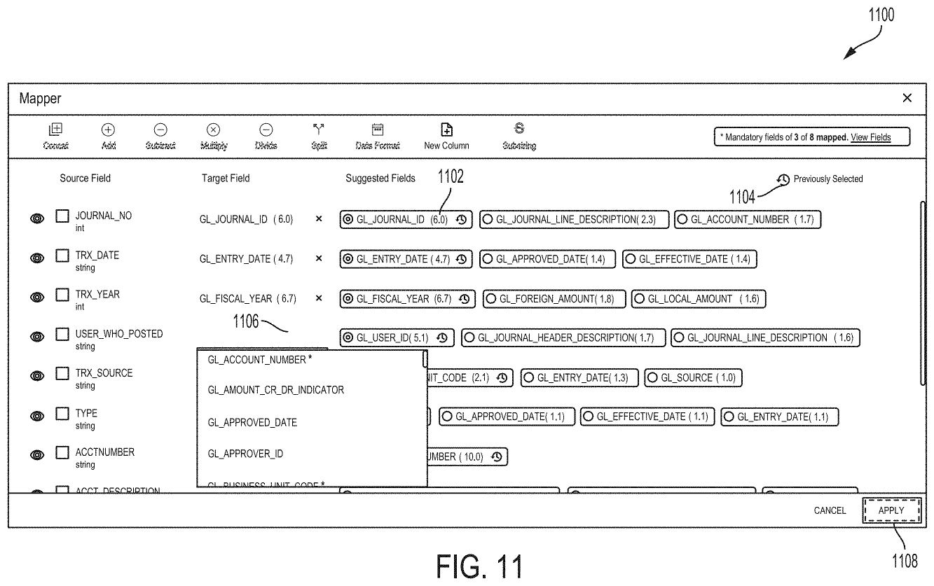

FIG. 11 illustrates a GUI 1100 for enabling a user to confirm correspondences between source data columns of a data file and target data columns of a target database, according to some embodiments. As described above with respect to FIG. 1, for each source data column of the data file, schema matcher 124 can be configured to determine one or more target data columns from the target database as suggested matches. In some embodiments, GUI 1100 displays graphical representations for each of the one or more target data columns determined for a source data column. For example, for source data column “Journal No,” GUI 1100 may display graphical representations corresponding to a set of target data columns including “GL_Journal ID,” “GL_Journal Line Description,” and “GL_Account_Number.” In some embodiments, in each graphical representation of a target data column, GUI 1100 can be configured to display a score 1102 representative of a confidence level that the data source column corresponds to this target data column. In some embodiments, score 1102 can be ranked from 1 to 10 where a higher score represents a greater confidence level or a higher likelihood of the correspondence.

In some embodiments, a previously selected icon 1104 can be displayed for one or more displayed graphical representations of target data columns to represent previous mappings that have been selected or confirmed by the user. In some embodiments, for each source data column, GUI 1100 enables the user to select one of the displayed graphical representations corresponding to one target data column or to enter a target data column in a dropdown menu 1106. In some embodiments, upon receiving the user's selection of a target data column corresponding to each source data column, GUI 1100 can enable the user to apply the correspondences through selection of the apply button 1108.

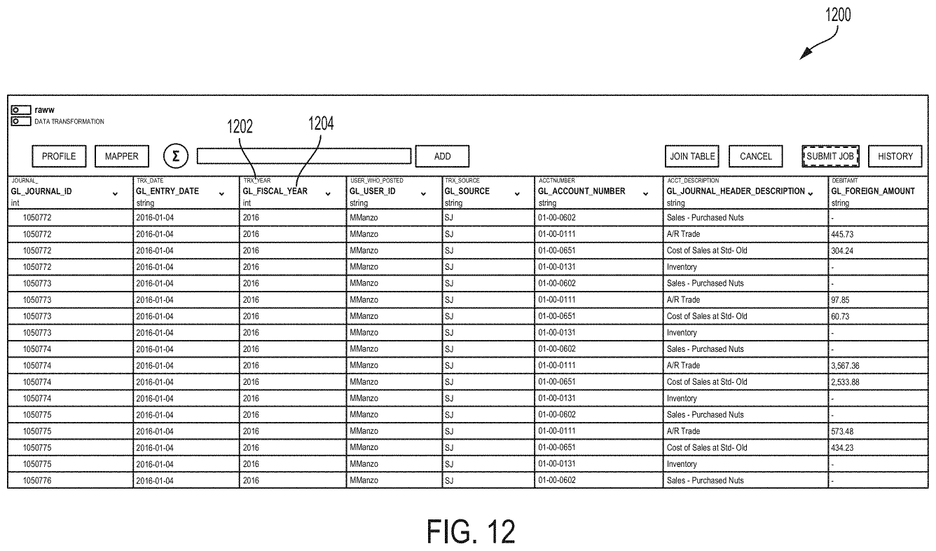

FIG. 12 illustrates a GUI 1200 showing schema mappings based on user-selected schema correspondences between source data columns of a data file and target data columns of a target database, according to some embodiments.

In some embodiments, in response to receiving the user's selection of apply button 1108 in GUI 1100, a schema mapper (e.g., schema mapper 126) of the data integration application can be configured to generate a data table having a data schema corresponding to the selected target data columns for storing the data of the plurality of source data columns of the data file. In some embodiments, the schema mapper can store the data of the data file in the data table. In some embodiments, GUI 1200 displays the generated data table including a plurality of data columns and a plurality of rows for storing the data of the data file. In some embodiments, GUI 1200 displays a mapped data column for each source data column of the data file. For example, GUI 1200 displays that a source data column previously titled “Trx_Year” 1202 has been mapped to a target data column titled “GL_Fiscal_Year” 1204, which is specified in a target schema of the target database.

In some embodiments, GUI 1200 enables the user to select the button for “Submit Job” to complete the data ingestion process. In some embodiments, in response to receiving the user's selection of the “Submit Job” button, the data integration application 112 can be configured to load the generated data table, shown in GUI 1200, into the target database.

FIG. 8 illustrates an example of a computer in accordance with some embodiments. Computer 800 can be a component of a system for automatically ingesting data from disparate data sources into a target database according to the systems and methods described above, such as server 110 of FIG. 1, or can include the entire system itself. In some embodiments, computer 800 is configured to execute a method for automatically ingesting data from disparate data sources into a target database, such as methods 600 and 700 of FIGS. 6 and 7, respectively.

Computer 800 can be a host computer connected to a network. Computer 800 can be a client computer or a server. As shown in FIG. 8, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein, such as methods 600 and 700 of FIGS. 6 and 7, respectively.

Software 850, which can be stored in storage 840 and executed by processor 810, can include, for example, the programming that embodies the functionality of the present disclosure (e.g., as embodied in the systems, computers, servers, and/or devices as described above). In some embodiments, software 850 can include a combination of servers such as application servers and database servers.

Software 850 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The preceding description sets forth exemplary methods, parameters and the like. It should be recognized, however, that such description is not intended as a limitation on the scope of the present disclosure but is instead provided as a description of exemplary embodiments. The illustrative embodiments described above are not meant to be exhaustive or to limit the disclosure to the precise forms disclosed. Many modifications and variations are possible in view of the above teachings. The embodiments were chosen and described to best explain the principles of the disclosed techniques and their practical applications. Others skilled in the art are thereby enabled to best utilize the techniques, and various embodiments with various modifications as are suited to the particular use contemplated.

Although the disclosure and examples have been thoroughly described with reference to the accompanying figures, it is to be noted that various changes and modifications will become apparent to those skilled in the art. Such changes and modifications are to be understood as being included within the scope of the disclosure and examples as defined by the claims. In the preceding description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

Although the preceding description uses terms first, second, etc. to describe various elements, these elements should not be limited by the terms. These terms are only used to distinguish one element from another.

Also, it is also to be understood that the singular forms “a,” “an,” and “the” used in the preceding description are intended to include the plural forms as well unless the context indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In some embodiments, a non-transitory computer-readable storage medium stores one or more programs configured to be executed by one or more processors of an electronic device, the one or more programs including instructions for implementing any of the steps described or claimed herein. The present disclosure also relates to a device for performing the operations herein. This device may be specially constructed for the required purposes, or it may include a general-purpose computer selectively activated or reconfigured by a computer program stored in the computer. Such a computer program may be stored in a non-transitory, computer computer-readable storage medium, such as, but not limited to, any type of disk, including floppy disks, optical disks, CD-ROMs, magnetic-optical disks, read-only memories (ROMs), random access memories (RAMs), electrically program read-only memories (EPROMs), electronically erasable program read-only memories EEPROMs, magnetic or optical cards, application specific integrated circuits (ASICs), or any type of media suitable for storing electronic instructions, and each coupled to a computer system bus. Furthermore, the computers referenced in this disclosure may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems appears from the description above. Also, the present disclosure is not described with reference to any particular programming language. It will be appreciated that a variety of programming languages may be used to implement the teachings of the present disclosure as described herein.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A method for automatically ingesting data from disparate data sources having respective data schemas into a target database having a target data schema, comprising:
receiving, from a user, a data file comprising a plurality of source data columns formatted according to a data schema of a data source and comprising a data dictionary comprising information describing the plurality of source data columns;
generating a plurality of count data for each cell of a plurality of cells selected from a source data column of the plurality of source data columns, each count datum comprising a number of occurrences of a characteristic detected in each cell;
selecting one or more target data columns from a plurality of target data columns specified in the target data schema as being semantically related to the source data column based on the plurality of count data for each cell, a column header of the source data column, and the data dictionary;
displaying, to the user, one or more graphical representations corresponding to the one or more target data columns selected for the source data column;
receiving an input from the user that selects a graphical representation corresponding to a first target data column from the one or more selected target data columns for the source data column;
storing the plurality of source data columns in a data table generated to transform the data schema of the data file into the target data schema of the target database, wherein the source data column corresponds to the first target data column; and
loading the generated data table into the target database.

2. The method of claim 1, wherein selecting one or more target data columns from the plurality of target data columns specified in the target data schema comprises:
determining one or more clusters from a plurality of clusters associated with the target data schema based on the plurality of count data for each cell; and
selecting a first set of data columns from the plurality of target data columns based on the one or more determined clusters, wherein the first set of data columns comprises the one or more target data columns.

3. The method of claim 2, comprising:
generating a second plurality of count data for each cell of a plurality of cells selected from each target data column of the plurality of target data columns of the target database;
clustering the plurality of cells for each target data column into the plurality of clusters based on the second plurality of count data for each cell; and
associating a set of target data columns from the plurality of target data columns with each cluster based on a number of cells from the set of target data columns being grouped into the cluster.

4. The method of claim 2, wherein determining the one or more clusters comprises:
executing a machine learning algorithm configured to assign a cluster from the plurality of clusters to each cell based on the plurality of count data for each cell.

5. The method of claim 2, wherein selecting one or more target data columns from the plurality of target data columns specified in the target data schema comprises:
selecting a second set of data columns from the first set of data columns based on header comparisons between the source data column and each target data column of the first set of data columns, wherein the second set of data columns comprises the one or more target data columns.

6. The method of claim 5, wherein selecting the second set of data columns comprises:
for each header comparison between the source data column and each target data column of the first set of data columns, determining a number of string operations to convert the source data column into the target data column; and
selecting the second set of data columns from the first set of data columns based on the number of string operations determined for each target data column of the first set of data columns.

7. The method of claim 6, wherein each of the string operations comprises deleting a character, adding a character, or substituting a character.

8. The method of claim 5, wherein selecting one or more target data columns from the plurality of target data columns specified in the target data schema comprises:
selecting a third set of data columns from the second set of data columns based on data description comparisons between the source data column and each target data column of the second set of data columns, wherein the third set of data columns comprises the one or more target data columns, and wherein the data dictionary comprises the data description for the source data column.

9. The method of claim 8, wherein selecting the third set of data columns from the second set of data columns comprises:
vectorizing a data description of the source data column to generate a source vector;
vectorizing the second set of data columns to generate a set of corresponding target vectors;
calculating a set of distances corresponding to distances between the source vector and each target vector of the set of target vectors; and
selecting the third set of data columns from the second set of data columns based on the set of calculated distances.

10. The method of claim 9, wherein the third set of data columns correspond to the one or more selected target data columns, comprising:
calculating one or more scores corresponding to the one or more selected target data columns based on the set of distances calculated for the third set of data columns; and
displaying the one or more scores proximate to the one or more graphical representations corresponding to the one or more selected target data columns.

11. The method of claim 1, wherein generating the plurality of count data comprises:
randomly selecting a predetermined number of cells from the source data column, wherein the predetermined number of cells corresponds to the plurality of selected cells.

12. The method of claim 1, wherein the number of occurrences of a characteristic detected in each cell comprises: a number of alphabetical characters in the cell, a number of digits in the cell, a number of white spaces in the cell, a number of special characters in the cell, a number of total characters in the cell, a number of people names identified in the cell, a number of location names identified in the cell, a number of nouns identified in the cell, or a number of verbs identified in the cell.

13. The method of claim 1, wherein displaying the one or more graphical representations corresponding to the one or more selected target data columns comprises:
displaying a graphical icon next to the first target data column from the one or more selected target data columns indicating that the first target data column was previously selected by the user for the source data column.

14. A system for automatically ingesting data from disparate data sources having respective data schemas into a target database having a target data schema, comprising:
one or more processors; and
memory storing one or more programs that when executed by the one or more processors cause the one or more processors to:
receive, from a user, a data file comprising a plurality of source data columns formatted according to a data schema of a data source and comprising a data dictionary comprising information describing the plurality of source data columns;
select a plurality of cells from a source data column of the plurality of source data columns;
generate a plurality of count data for each cell of the plurality of cells, each count datum comprising a number of occurrences of a characteristic detected in each cell;
select one or more target data columns from a plurality of target data columns specified in the target data schema as being semantically related to the source data column based on the plurality of count data for each cell, a column header of the source data column, and the data dictionary;
display, to the user, one or more graphical representations corresponding to the one or more selected target data columns for the source data column;
receive an input from the user that selects a graphical representation corresponding to a first target data column from the one or more selected target data columns for the source data column; and
store the plurality of source data columns in a data table generated to transform the data schema of the data file into the target data schema of the target database, wherein the source data column corresponds to the first target data column; and
load the generated data table into the target database.

15. The system of claim 14, wherein to select one or more target data columns from the plurality of target data columns specified in the target data schema, wherein the one or more processors are caused to:
determine one or more clusters from a plurality of clusters associated with the target data schema based on the plurality of count data for each cell; and
select a first set of data columns from the plurality of target data columns based on the one or more determined clusters, wherein the first set of data columns comprises the one or more target data columns.

16. The system of claim 15, wherein the one or more processors are caused to:
generate a second plurality of count data for each cell of a plurality of cells selected from each target data column of the plurality of target data columns of the target database;
cluster the plurality of cells for each target data column into the plurality of clusters based on the second plurality of count data for each cell; and
associate a set of target data columns from the plurality of target data columns with each cluster based on a number of cells from the set of target data columns being grouped into the cluster.

17. The system of claim 15, wherein to determine the one or more clusters, the one or more processors are caused to:
execute a machine learning algorithm configured to assign a cluster from the plurality of clusters to each cell based on the plurality of count data for each cell.

18. The system of claim 15, wherein to select one or more target data columns from the plurality of target data columns specified in the target data schema, the one or more processors are caused to:
select a second set of data columns from the first set of data columns based on header comparisons between the source data column and each target data column of the first set of data columns, wherein the second set of data columns comprises the one or more target data columns.

19. The system of claim 18, wherein to select the second set of data columns, the one or more processors are caused to:
for each header comparison between the source data column and each target data column of the first set of data columns, determine a number of string operations to convert the source data column into the target data column; and
select the second set of data columns from the first set of data columns based on the number of string operations determined for each target data column of the first set of data columns.

20. The system of claim 19, wherein each of the string operations comprises deleting a character, adding a character, or substituting a character.

21. The system of claim 18, wherein to select one or more target data columns from the plurality of target data columns specified in the target data schema, the one or more processors are caused to:
select a third set of data columns from the second set of data columns based on data description comparisons between the source data column and each target data column of the second set of data columns, wherein the third set of data columns comprises the one or more target data columns, and wherein the data dictionary comprises the data description for the source data column.

22. The system of claim 21, wherein to select the third set of data columns from the second set of data columns, the one or more processors are caused to:
vectorize a data description of the source data column to generate a source vector;
vectorize the second set of data columns to generate a set of corresponding target vectors;
calculate a set of distances corresponding to distances between the source vector and each target vector of the set of target vectors; and
select the third set of data columns from the second set of data columns based on the set of calculated distances.

23. The system of claim 22, wherein the third set of data columns correspond to the one or more selected target data columns, and the one or more processors are caused to:
calculate one or more scores corresponding to the one or more selected target data columns based on the set of distances calculated for the third set of data columns; and
display the one or more scores proximate to the one or more graphical representations corresponding to the one or more selected target data columns.

24. The system of claim 14, wherein to generate the plurality of count data. the one or more processors are caused to:
randomly select a predetermined number of cells from the source data column, wherein the predetermined number of cells corresponds to the plurality of selected cells.

25. The system of claim 14, wherein the number of occurrences of a characteristic detected in each cell comprises: a number of alphabetical characters in the cell, a number of digits in the cell, a number of white spaces in the cell, a number of special characters in the cell, a number of total characters in the cell, a number of people names identified in the cell, a number of location names identified in the cell, a number of nouns identified in the cell, or a number of verbs identified in the cell.

26. The system of claim 1, wherein to display the one or more graphical representations corresponding to the one or more selected target data columns, the one or more processors are caused to:
display a graphical icon next to the first target data column from the one or more selected target data columns indicating that the first target data column was previously selected by the user for the source data column.

27. A non-transitory computer-readable storage medium comprising instructions for ingesting data from disparate data sources having respective data schemas into a target database having a target data schema, wherein the instructions, when executed by one or more processors, cause the one or more processors to perform instructions comprising:
receiving, from a user, a data file comprising a plurality of source data columns formatted according to a data schema of a data source and comprising a data dictionary comprising information describing the plurality of source data columns;
generating a plurality of count data for each cell of a plurality of cells selected from a source data column of the plurality of source data columns, each count datum comprising a number of occurrences of a characteristic detected in each cell;
selecting one or more target data columns from a plurality of target data columns specified in the target data schema as being semantically related to the source data column based on the plurality of count data for each cell, a column header of the source data column, and the data dictionary;
displaying, to the user, one or more graphical representations corresponding to the one or more target data columns selected for the source data column;
receiving an input from the user that selects a graphical representation corresponding to a first target data column from the one or more selected target data columns for the source data column;
storing the plurality of source data columns in a data table generated to transform the data schema of the data file into the target data schema of the target database, wherein the source data column corresponds to the first target data column; and
loading the generated data table into the target database.
